(19) United States
(12) Patent Application Publication
(10) Pub. No.: US 2019/0068734 A1
(43) Pub. Date: Feb. 28, 2019

(54) NOTIFICATION API FOR EXTERNAL IDENTIFICATION

(71) Applicant: Microsoft Technology Licensing, LLC, Redmond, WA (US)

(72) Inventors: Ross Garrett Cutler, Redmond, WA (US); Jevgeni Smorov, Redmond, WA (US); Antti Pekka Kelloniemi, Kirkland, WA (US); Vikram Khandpur, Kirkland, WA (US)

(21) Appl. No.: 15/685,409

(22) Filed: Aug. 24, 2017

(51) Int. Cl. H04L 29/08; H04L 12/58

(52) U.S. Cl. CPC H04L 67/26; H04L 51/38; H04L 51/24; H04L 69/329

(57) ABSTRACT

Systems, methods, and software are disclosed herein for providing notifications on an external device. In an implementation, a computing apparatus comprises one or more computer readable storage media, a processing system operatively coupled with the one or more computer readable storage media, and program instructions stored on the one or more computer readable storage media for automatically joining a user to a conference session. The program instructions direct the processing system to detect an invocation of an application and, in response to detection of the invocation, send a context request to an external device. The program instructions further direct the processing system to receive from the external device a context response comprising a notification type, determine whether the notification type corresponds with a meeting type, and automatically join a user to the conference session within the application if the notification type corresponds with the meeting type.

### TECHNICAL BACKGROUND

A great deal of software technology exists that allows users to participate in audio/video conference sessions and other types of multi-user communication exchanges. MICROSOFT SKYPE (with Business and Consumer versions), MICROSOFT TEAMS, and GOOGLE+ HANGOUTS are only a few examples of technology offerings in the marketplace today.

Users typically participate in such sessions through an application client running on their own device. A familiar scenario might involve users engaging in a video conference with each other from their desks or individual work space via a client running on their desktop computer, laptop computer, tablet, or mobile phone.

To engage in a conference with others, a user may have to perform a series of user selections in order to join the conference. For example, if the application client is not on the foreground as the active client on the device, the user must switch to the application client (or start and log in to the application if it is not running) followed by one or more selections to find and join a desired conference. Of course, such user interaction requires the user to have the device that is running the application client at hand and be manipulating the device in order to make the user interactions.

In a hands-free conference scenario, the user may wish to have the audio of the other participants in the conference broadcast from an external speakerphone, which may be of a higher quality and allow for a higher loudness than a speaker built into the device. The external speakerphone may also capture the user's voice in order to send it to the other conference participants.

Visual or other type of notifications for scheduled conferences may be typically displayed on the device to alert the user of one or more conferences that are ready to be joined. However, the device may not be at hand when such notifications occur such as when the device is in the user's pocket or other location. However, while the device may not be visible, the external speakerphone may not move far from its accustomed location and may be visible to the user at all times. Indicators on the external speakerphone may indicate a current status of the external speakerphone such as its availability for use or its active use in a conference, but notifications from the device are not transmitted for indication on the external speakerphone.

### Overview

Examples discussed herein relate to an Application Programming Interface (API) for a conferencing client that overcomes the aforementioned drawbacks. In an implementation, a computing apparatus comprises one or more computer readable storage media, a processing system operatively coupled with the one or more computer readable storage media, and program instructions stored on the one or more computer readable storage media for automatically joining a user to a conference session. When executed by the processing system, the program instructions direct the processing system to detect an invocation of an application and, in response to detection of the invocation, send a context request to an external device. The program instructions further direct the processing system to receive from the external device a context response comprising a notification type, determine whether the notification type corresponds with a meeting type, and automatically join a user to the conference session within the application if the notification type corresponds with the meeting type.

In another implementation, a method for automatically joining a user to a conference session comprises detecting an invocation of a client application and, in response to detecting the invocation, sending a context request to an external device. The method also comprises receiving from the external device a context response comprising a notification type, determining whether the notification type corresponds with a meeting type, and automatically joining a user to the conference session within the client application if the notification type corresponds with the meeting type.

In a further implementation, a communication device comprises one or more computer readable storage media and program instructions stored on the one or more computer readable storage media for automatically joining a user to a conference session. The program instructions, when executed by a processing system, direct the processing system to request a notification type from an external device in response to invocation of a conferencing client application running on the communication device; determine, in response to receiving the notification type from the external device, a classification of the notification type; and if the classification corresponds with a meeting type, automatically join a user to the conference session within the conferencing client application.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a conferencing environment in an implementation.

FIG. 2 illustrates an external device in an implementation.

FIG. 3 illustrates a communication device in an implementation.

FIGS. 4A-D illustrate a user experience in a communication client in an implementation.

FIG. 5 illustrates an external device notification process employed by the conferencing environment in an implementation.

FIG. 6 illustrates an operational sequence in an implementation.

FIG. 7 illustrates a computing system suitable for implementing the software technology disclosed herein, including any of the applications, architectures, elements, processes, and operational scenarios and sequences illustrated in the Figures and discussed below in the Detailed Description.

### DETAILED DESCRIPTION

Before any embodiments are explained in detail, it is to be understood that the embodiments described herein are not limited in their application to the details of construction and the arrangement of components set forth in the following description or illustrated in the following drawings. Embodiments may be practiced or carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “connected” and “coupled” are used broadly and encompass both direct and indirect mounting, connecting, and coupling. Further, “connected” and “coupled” are not restricted to physical or mechanical connections or couplings, and may include electrical connections or couplings, whether direct or indirect. Also, electronic communications and notifications may be performed using any known means including direct or indirect wired connections, wireless connections, and combinations thereof. Also, functionality described as being performed by one device may be distributed among a plurality of devices.

It should also be noted that a plurality of hardware and software based devices, as well as a plurality of different structural components may be used to implement the embodiments set forth herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments may be implemented in software (e.g., stored on non-transitory computer-readable medium) executable by one or more electronic processors.

Peripheral device control technology is disclosed herein that provides interaction between a communication device and an external, peripheral device connected thereto. A conferencing application running on the communication device may authenticate itself with the external device to gain control of the external device. Once authenticated, the conferencing application may cause the external device to indicate to a user that the conferencing application has an active user notification that has not been cleared.

In an implementation, the conferencing application sends a notification type to the external device for correspondingly indicating the notification type to the user. For example, the notification type may cause the external device to indicate that the user has an upcoming conferencing meeting, that the conferencing application received a call or an instant message from a third-party that the user did not answer or acknowledge (e.g., missed call or missed instant message), or that the conferencing application has a recorded voicemail ready for the user left, for example, by the third-party in response to the missed call. Other notification types such as unread text messages, reminder events, and the like are also contemplated herein.

In one implementation where the external device received reduced information, the notification type transmitted to the external device has the information used by the external device to indicate the notification type but does not include specific details regarding the notification. For an upcoming conference meeting, the notification type indicates that there is an upcoming conference meeting, but any details regarding the conference meeting such as, for example, the subject of the meeting, the meeting participants, meeting notes, etc. are not transmitted to the device for user notification. Accordingly, any indication by the external device that there is an upcoming conference meeting merely indicates that there is a meeting. If the user wants to know the meeting particulars, the meeting information can be found on the communication device and the conferencing application. Likewise, notifications on the external device of missed calls or instant messages or of a recent voicemail do not notify the user of the third-party who called, messaged, or left a voicemail or the time in which the third-party did so.

The external device, in response to receiving the notification type from the conferencing application, may cause a different indication to be activated depending on the notification type. For example, the external device may include one or more of a visual indicator, an audio indicator, a haptic indicator, or the like. A different style of light, sound, and/or vibrational excitation may be used to indicate the different notification types. In one implementation, differently-colored light-emitting diodes (LEDs) or one or more multi-colored LEDs may be controlled to visually indicate a different notification type. A unique color and/or flash pattern may be used for each respective indication type so that the user understands which type of notification is awaiting his attention in the conferencing application. Appropriate sets of unique schemes or patterns may correspondingly be used for audio and haptic indications alternatively or in addition to the visual indications.

A user input on the external device, such as a push button or a capacitive touch button, causes the external device to send a command to the communication device to switch to the communication application as the active, foreground process. Alternatively, the external device may receive the user input through another input type such as voice commands, etc. In response, the communication application queries the external device to find out which notification type was active in the external device when it received the user input. Based on the notification type indicated in the response from the external device, the conferencing application can direct its user experience directly to the appropriate operation. For example, if the active notification type on the external device corresponded with a missed call or instant message, the conferencing application can show the list of missed calls or instant messages to the user. Likewise, the conferencing application can show the list of voicemails if the active notification type corresponded with a voicemail. In one implementation, the conferencing application may cause the communication device to audibly broadcast the information related to the missed call or instant message or to read the recorded voicemails out loud. In addition, the conferencing application may provide the audible information to the external speaker to be broadcast over its speaker.

If the active notification type on the external device corresponded with an upcoming conference meeting, rather than merely displaying the list of upcoming conference meetings to the user, the conferencing application may instead or in addition thereto automatically join the conferencing session. In this manner, the user, with only a single action through the interaction with the external device, may be joined to the upcoming conference meeting without further actions on his part. That is, the user does not have to interact with the external device to make the conferencing application active on the communication device followed by a further interaction in the conferencing application to manually join the upcoming or scheduled conference meeting.

In one embodiment, the conferencing application, after receiving the notification type response from the external device, may send a communication back to the external device to clear or remove the notification indication so that the external device does not continue to indicate the notification type after the notification has been addressed in the communication application. In another embodiment, the external device may clear the notification without waiting for a command from the conferencing application to clear the notification. In one embodiment, the external device only maintains the most-recent notification type. Accordingly, clearance of that notification type can cause any notification indicators on the external device to be inactive. It is then not until the conferencing application sends a subsequent notification type to the external device that the notification indicator(s) on the external device becomes active again.

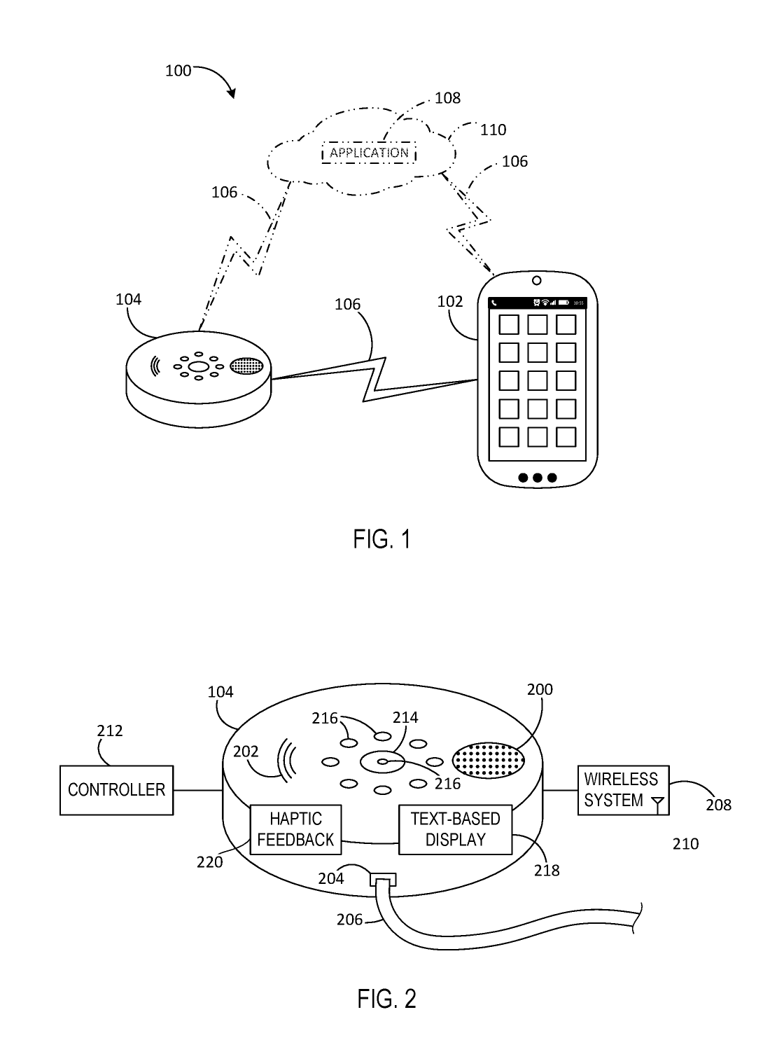

FIG. 1 illustrates a conferencing environment 100 in an implementation of communication between a communication device 102 and an external device or communication endpoint 104. Communication device 102 is representative of a mobile phone, tablet, laptop, or any other suitable computing and communication device. External device 104 is representative of a conference device of the speakerphone type allowing conference users to hear and speak to other conference participants.

A communication medium 106 connects communication device 102 to external device 104 for exchanging communications and telephony services therebetween. In one implementation, communication medium 106 comprises a wireless medium, and communication device 102 is connected to external device 104 via a near field communications (NFC) protocol, via a Bluetooth protocol, via a WiFi protocol, or via another type of wireless protocol known in the art. In another implementation, communication medium 106 comprises a wired medium where communication device 102 is connected to external device 104 via a network cable, via a Universal Serial Bus (USB) cable, via a Lightning cable, or the like. In a preferred implementation, communication medium 106 provides a direct line of communication between communication device 102 and external device 104 without the need for additional communication system hardware. In this manner, the location of external device 104 being near communication device 102 is desired. Accordingly, when the communication device 102 is moved to a location outside of the locality of the external device 104, the communication device 102 and the external device 104 become disconnected, which prevents a third-party from interacting with a user's communication device 102 via the external device 104 when the user is no longer present.

However, implementations are contemplated herein that may include additional communication system hardware such as a server, a router, and the like to couple communication device 102 to external device 104. For example, the communication system hardware may allow the external device 104 to be coupled to communication device 102 via an application 108 running in the cloud 110, in one embodiment.

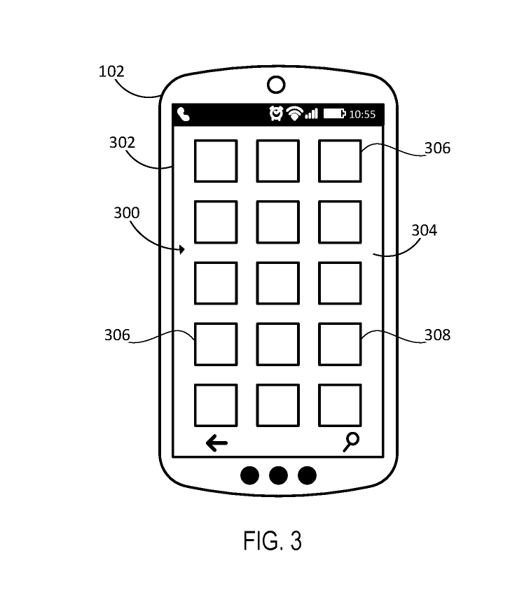

FIG. 2 illustrates external device 104 in an implementation. External device 104 comprises a speakerphone having a speaker 200 for broadcasting audio and a microphone 202 for receiving audio. As indicated above, external device 104 may be connected to communication device 102 via a wired or a wireless connection. To facilitate a wired connection, external device 104 includes a wired connection port 204 couplable to a cable or other wire 206 connected directly to communication device 102 in some implementations. Cable 206 includes a network cable, USB cable, or the like. To facilitate a wireless connection, external device 104 includes a wireless system 208 with an antenna 210 wirelessly connectable to communication device 102 via a near field communications (NFC) protocol, via a Bluetooth protocol, via a WiFi protocol, or via another type of wireless protocol known in the art. External device 104 further includes a controller 212 programmed to communicate with communication device 102 and perform the external device aspects of the notification API disclosed herein.

A user interface 214 in the form of a button in one implementation and in the form of a voice-controlled system in another implementation is provided to receive a user interaction as described herein. A plurality of visual indicators 216 may be provided to visually indicate a pending notification received from the communication device 102. Further, a text-based display 218, such as a liquid crystal display or similar display, may be included to provide visual indications instead of or in addition to the plurality of visual indicators 216. In addition, a haptic feedback system 220 may be provided to provide a haptic indication of the pending notification, and the speaker 200 may be controlled to provide an audio indication of the pending notification.

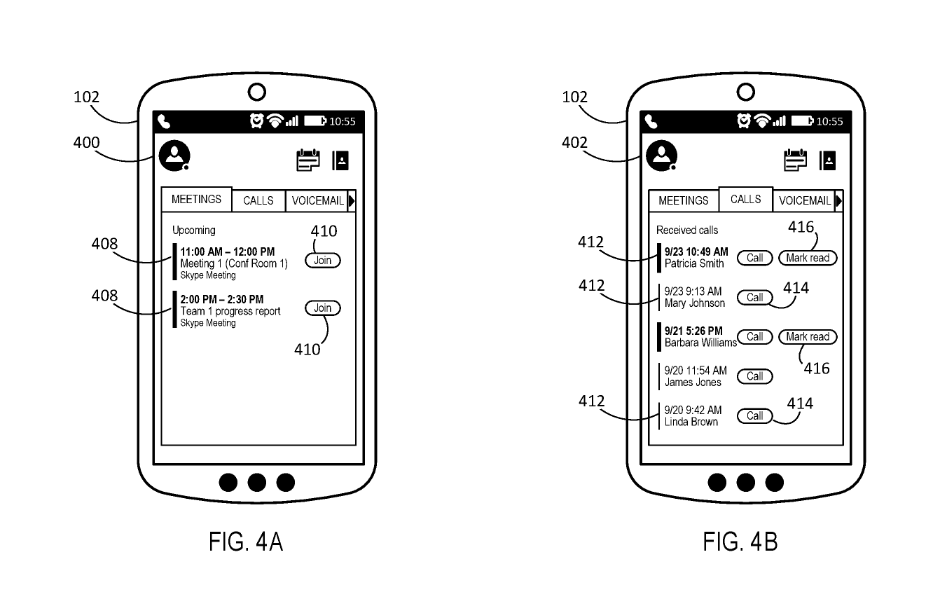

FIG. 3 illustrates communication device 102 in an implementation. A user interface 300 is rendered on a screen 302 of communication device 102. As shown, user interface 300 includes a home screen 304 with various icons 306 for launching applications on the device. Each icon may correspond to an application, a contact, a file, or any other such element. A communication application 308 running on communication device 102 allows a user to participate in audio/video conference sessions and in other types of operations such as receiving voice calls, voicemail, text messaging, and the like. Examples of communication application 308 include, but are not limited to, MICROSOFT SKYPE (including Skype for Business) and MICROSOFT TEAMS.

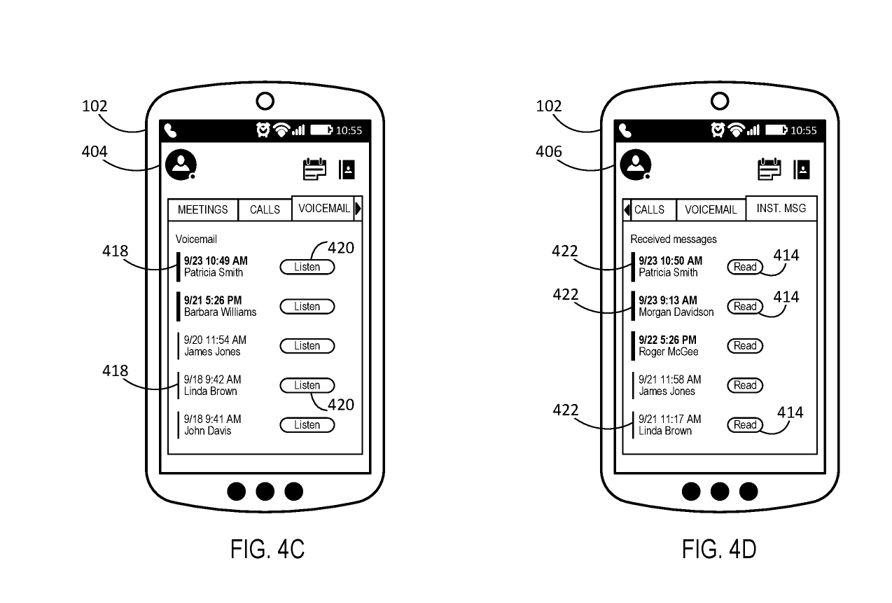

FIGS. 4A-D illustrate a plurality of user experiences 400, 402, 404, 406 of communication application 308 executed on communication device 102 in an implementation. User experience 400 shows a meeting user experience that lists for the user upcoming and other scheduled conference meetings. One or more scheduled meetings 408 are listed for the user. Meetings 408 listed in user experience 400 have a conference aspect in which attending the meeting includes joining a multi-user conference session. The user experience 400 provides a respective user input 410 for each meeting 408 to allow the user to manually join the respective conference meeting through interaction with the user input 410. Instead or in addition thereto, the meeting 408 may also be joined by the user touching the meeting 408. The list of meetings may show meeting details such as the date/time of the scheduled meeting, the subject of the scheduled meeting, and its location if the meeting is additionally being held in a preconfigured location. Other meeting details may further be displayed as desired.

User experience 402 shows a list of received calls 412 that user received on the communication device 102 via the communication application 308 that were not answered by the user. In one implementation, each received call 412 shows call details such as the date and time of the missed call as well as the name or other information of the third-party who called. Each call 412 in the list may also be accompanied by a respective call-back user input 414 to allow the user to return the call to the third-party as well as a respective mark-as-read user input 416 to allow the user to indicate to the communication application 308 that the received call 412 received the user's attention. Instead or in addition thereto, the received call 412 may also be listened to by the user touching the received call 412.

User experience 404 shows a list of voicemail messages 418 received and recorded on the communication device 102 via the communication application 308. Each voicemail message 418 shows call details such as the date and time of the voicemail as well as the name or other information of the third-party who left the voicemail. Each voicemail message 418 in the list may also be accompanied by a respective listen user input 420 to allow the user to listen to the recorded voicemail messages. Instead or in addition thereto, the voicemail message 418 may also be listened to by the user touching the voicemail message 418.

User experience 406 shows a list of instant message conversations 422 received from third-parties. Each instant message conversation 422 shows instant message details such as the date and time of the message as well as the name or other information of the third-party who sent an instant message. Each instant message conversation 422 in the list may also be accompanied by a respective read user input 424 to allow the user to listen to open the instant message conversation and view messages related thereto. Instead or in addition thereto, the instant message conversation 422 may also be opened by the user touching the instant message conversation 422.

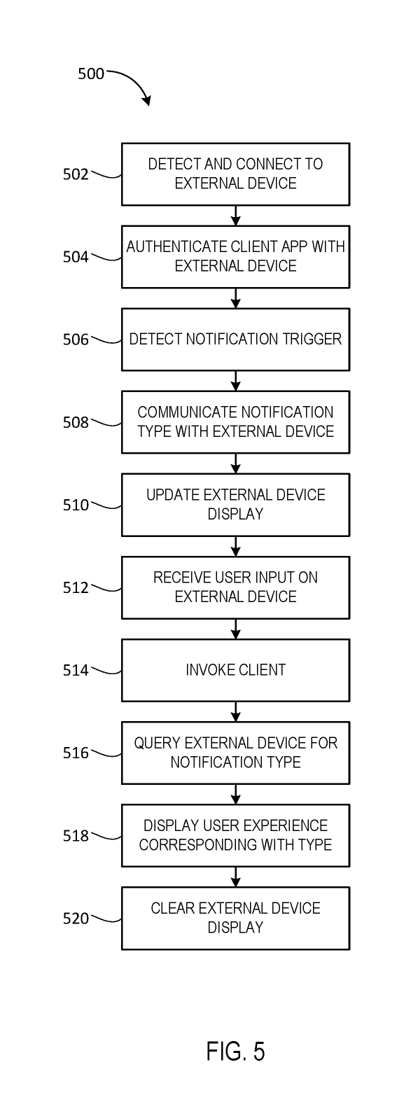

FIG. 5 illustrates an external device notification process 500 employed in the conferencing environment 100 in an implementation. Call handling process 500 may be implemented in program instructions in the context of any of the software applications, modules, components, or other such programming elements that comprise a given notification service running in conferencing environment 100. The program instructions direct the underlying physical or virtual computing system or systems that provide the notification service to operate as follows.

Referring parenthetically to the steps illustrated in FIG. 5, external device notification process 500 begins with the detection and connection of the communication device 102 to the external device 104 (step 502). In a typical implementation, an operating system in operation on communication device 102, which also executes the communication application 308, is responsible for detecting external peripheral devices and controlling recognition and connection to the communication device 102. For example, the operating system may become connected to the external device 104 through a pairing protocol in either a wireless or a wired scenario. Accordingly, once the external device 104 becomes paired with the communication device 102 and/or the operating system, the external device 104 may be accessible to applications running on the communication device 102.

In an implementation, external device 104 controls authentication with a client application trying to gain access therewith. Accordingly, even though the external device 104 may be paired with the operating system of communication device 102, external device 104 may separately grant or deny client application access thereto. As such, the client application such as the communication application 308 running in the operating system on communication device 102 petitions or requests authentication with external device 104 (step 504). Authentication of the communication application 308 with the external device 104 allows the communication application 308 to send notification tasks to the external device 104 for an additional source of notification indication to the user.

As described herein, the communication application 308 is a conferencing application in one embodiment that allows the user to join a multi-user conference session and participate via audio and/or video communication channels. In addition, the communication application 308 is configured to receive telephony or voice calls and to record voicemails if a telephone call is not answered. The communication application 308, within the application itself, is capable of notifying the user of upcoming conference meetings and of missed phone calls and left voicemails. While the communication application 308 is authenticated with the external device 104, these notifications may also be transmitted to the external device 104 for providing additional ways to notify the user of the respective notifications. Accordingly, the communication application 308 detects a notification triggered from the receipt of a missed call or instant message or of a recorded voicemail message or of a meeting reminder of an upcoming or pending conference meeting (step 506). The meeting reminder may be generated a certain amount of time before the meeting such as 15 minutes before the scheduled meeting and may be again generated at the time when the meeting is scheduled to start, as examples.

After detecting the notification trigger, the communication application 308 communicates the notification to the external device 104 (step 508), which updates its notification indicator accordingly (step 510). The notification communicated to the external device 104 comprises the type of notification (e.g., conference meeting, missed call, missed instant message, or voicemail), but the details of the notification regarding dates, times, and other detail-specific information is not communicated. In this manner, private or other sensitive information to the user may not wish to have transmitted to an external device in this context remains with the user's device.

The external device 104 updates its display based on the type of notification received from the communication application 308. The external device 104 may include a pre-arranged indication pattern for each notification type. For example, if visual indicators 216 such as LEDs are used, the LEDs of a certain color may be controlled according to a particular light pattern for one notification type, and the LEDs of a different color may be controlled according to the same or different light pattern for a different notification type. Alternatively, same- or multi-colored LEDs may be controlled according to different light patterns for different notification types. The different light patterns may be, for example, different blinking patterns, different color patterns, or the like. The user interface 214 of external device 104 may incorporate a visual indicator instead of or in addition to the visual indicators 216 and may be controlled in a similar manner. In addition, distinctive notification patterns may be controlled in a like manner in speaker 200, in text-based display 218, or in haptic feedback system 220 if used.

In one implementation, the notification is communicated to the external device 104 only once after it is generated, and a subsequent notification communicated to the external device 104 overrides any previous notification such that the external device 104 displays or indicates only the most recent notification. Accordingly, if a previous notification on the external device 104 is overwritten by a new notification, such as a different notification type, the new notification is indicated on the external device 104. Furthermore, since the previous notification is not again communicated to the external device 104 because it is only generated once, when the new notification is cleared from the external device 104, the previous active notification is not recalled to be in an active notification status on the external device 104.

Following receipt of the notification type from the communication application 308, the external device 104 waits in the notification indication state until the receipt of a newer notification type from the communication application 308 or an input from the user via user interface 214 (step 512). In response to the external device 104 receiving the user input through user interface 214, the external device 104 communicates with the operating system of the communication device 102 to invoke activation of the communication application 308 as a foreground process (step 514). The communication application 308 may become de-activated as a foreground process through user interaction with the operating system and/or other application clients running within the operation system on the communication device 102. In this manner, the operation system may change the communication application 308 from running as a foreground process into running as a background process.

When invoked into running as a foreground process from a background process, the communication application 308 may detect or already have knowledge of the external device 104 so as to cause the communication application 308 to query the external device 104 to determine if it received a user input through user interface 214 (step 516) to cause the communication application 308 to be invoked from the external device 104. The response from the external device 104 will indicate whether the invocation of the communication application 308 was the result of the external device 104 receiving a user input through user interface 214. If so, the response may contain the notification type then currently active on the external device 104. If not, the response may be “none” or some other message indicative of no user input having yet been received by the external device 104.

If the response from the external device 104 contains a notification type, the communication application 308 displays and makes active the corresponding user experience 400-404 on the display of the communication device 102 (step 518). For example, if the notification type being indicated on the external device 104 was for a missed call or missed instant message when the user pushed or otherwise interacted with the user interface 214, then the communication application 308 displays the missed call user experience 402 or the missed instant message user experience 406, respectively. Likewise, for an active voicemail notification being indicated on the external device 104, the communication application 308 displays the voicemail user experience 404.

If the notification type being indicated on the external device 104 was for an upcoming or pending scheduled conference meeting when the user pushed or otherwise interacted with the user interface button 214, the communication application 308 may display the meeting user experience 400 and automatically join the user to the conference session corresponding to the pending conference meeting 408. In this manner, the user does not have to interact both with the user interface button 214 (in order to invoke the meeting user experience 400) and with the meeting's user input 410. Instead, through the single action of interacting with the user interface button 214, the user is automatically joined to the appropriate conference session via the communication application 308. Accordingly, in this scenario, the user may be able to avoid interaction with the communication device 102 or the communication application 308 at all if desired in order to be joined to the conference session. After being joined to the conference session, the speaker 200 and microphone 202 may be used to audially interact with the conference participants.

After receiving the notification type response from the external device 104, the communication application 308 may communicate a notification type to the external device 104 that causes the external device 104 to remove or clear any currently active notification indication (step 520). Thereafter, in response to receiving a fresh notification trigger, external device notification process 500 may begin again at step 506 to cause the notification to be indicated on the external device 104 as described herein.

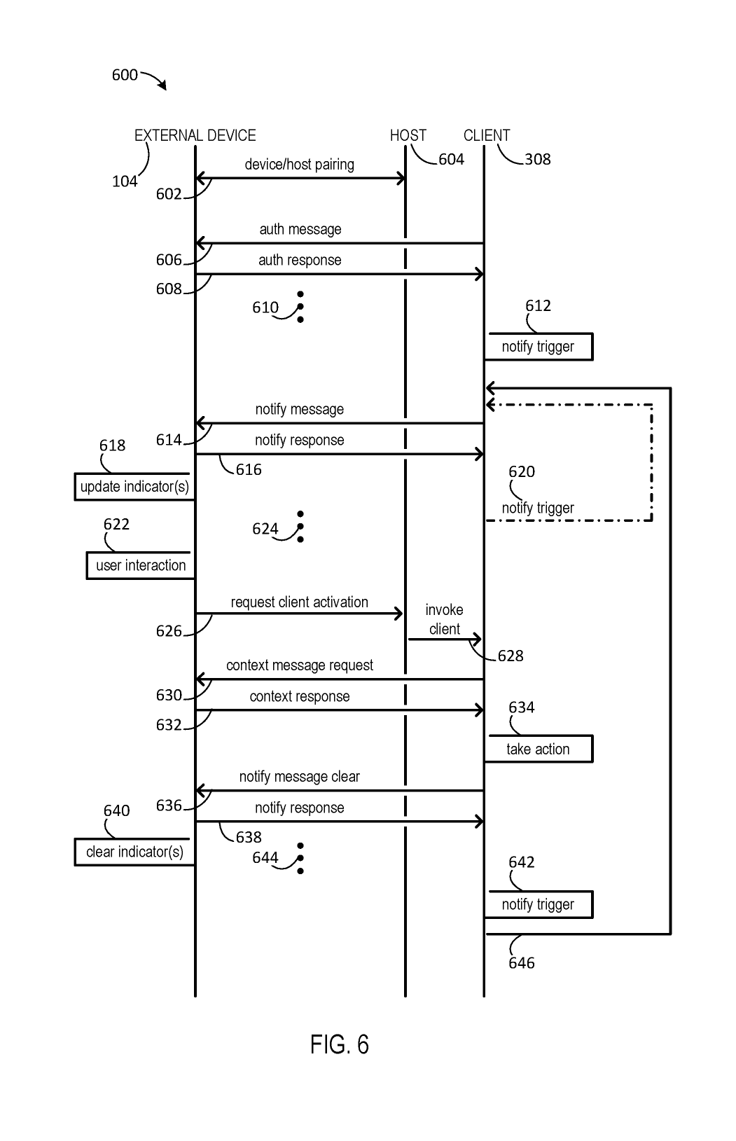

FIG. 6 illustrates an operational sequence 600 to demonstrate external device notification indication with respect to conferencing environment 100 and external device notification process 500. In FIG. 6, operational sequence 600 begins with the pairing or other similar connecting (602) of the external device 104 to a host 604 such as the operating system executed or running on the communication device 102 to allow interaction with the external device 104 from applications or clients such as the communication application 308 running in the host 604 on the communication device 102.

After determining that the external device 104 is available, the communication application 308 tries to authenticate itself with the external device 104 in order to have the external device 104 display or otherwise indicate its notification types. Authentication may include sending an authorization message (606) from the communication application 308 to the external device 104 that may include, for example, the keyword or command identifier “auth:” followed by the ID of the communication application 308. The external device 104 may be programed to allow authorization from one or more distinct types or versions of conferencing/collaboration clients such as, for example, Microsoft Skype For Business and Microsoft Teams. In one implementation, the external device 104 may be programed to only allow authorization from business-style clients such that a non-business client such as Microsoft Skype For Consumer is not able to be authorized by the external device 104 for interaction therewith.

The communication client application 308 may receive an authorization response (608) from the external device 104 indicating whether authorization was granted. The authorization response may, for example, take the form of the keyword “auth:” followed by an authorized indicator such as “accepted” or a non-authorized indicator such as an error condition indicating why authorization was not granted.

After an optional asynchronous amount of time (610) thereafter, a trigger notification (612) may occur within the client 308. Such trigger notifications may include, for example, conference meeting reminders, missed-call notifications, or recorded voicemail notifications. In response, the client 308 sends a notify message (614) to the external device 104 in a context message that may take the form of the keyword “notify:” followed by the notification type (e.g., “missedcall”, “voicemail”, “meeting”, “IM”, “none”). The external device 104 may then respond with a notify response (616) that may take the form of the keyword “notify:” followed by “accepted” if the notification is acknowledged and accepted or followed by an error condition indicating why notification was not accepted. Thereafter, the external device 104 updates (618) its notification indicator(s) as described herein.

If a newer, more recent trigger notification (620) is generated in the client 308 prior to any user interaction (622) on the external device 104, it is communicated to the external device 104 via the notification message and response processes (614, 616).

In response to receiving the user interaction (622) after some time has passed (624), the external device 104 requests (626) of the host (604) that the client 308 be activated or invoked into running as a foreground process. The host (604) then invokes (628) the client 308.

In response to being invoked by the external device 104, the client 308 sends a context message request (630) to the external device 104 to find out what notification type was actively indicated on the external device 104 when the user interaction (622) occurred. The context message request may take the form of the keyword “context:” followed by the keyword “request” or followed by the ID of the communication application 308. The external device 104 may then respond with a context response (632) that may take the form of the keyword “context:” followed by the notification type (e.g., “missedcall”, “voicemail”, “meeting”, “IM”, “none”) or followed by an error condition indicating why notification was not accepted. If the client 308 transmits the context message request (630) and no notification type was being indicated on the external device 104, the “none” keyword of the notification type may be sent as the context response (632).

If the context response (632) indicates that a meeting, missed call, missed instant message, or voicemail notification type was active on the external device 104, the client 308 takes action (634) by displaying the appropriate user experience correlating with the notification type and/or automatically joining the conference session for a pending conference meeting as described herein. In response, the client 308 sends a notification message (636) to the external device 104 in a context message that may take the form of the keyword “notify:” followed by the keyword “clear”. The external device 104 may then respond with a notify response (638) that may take the form of the keyword “notify:” followed by “accepted” if the notification is acknowledged and accepted or followed by an error condition indicating why notification was not accepted. Thereafter, the external device 104 clears and de-activates the notification indicators (640).

A subsequent trigger notification (642) occurring sometime thereafter (644) in the client 308 restarts (646) the notification sequence.

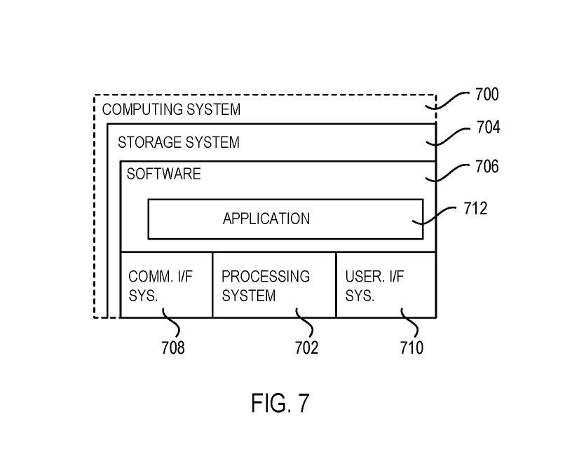

FIG. 7 illustrates a computing system 700, which is representative of any system or collection of systems in which the various applications, services, scenarios, and processes disclosed herein may be implemented. Examples of computing system 700 include, but are not limited to, desktop computers, laptop computers, tablet computers, computers having hybrid form-factors, mobile phones, smart televisions, wearable devices, server computers, blade servers, rack servers, and any other type of computing system (or collection thereof) suitable for carrying out the application launching operations described herein. Such systems may employ one or more virtual machines, containers, or any other type of virtual computing resource in the context of supporting enhanced group collaboration.

Computing system 700 may be implemented as a single apparatus, system, or device or may be implemented in a distributed manner as multiple apparatuses, systems, or devices. Computing system 700 includes, but is not limited to, processing system 702, storage system 704, software 706, communication interface system 708, and user interface system 710. Processing system 702 is operatively coupled with storage system 704, communication interface system 708, and user interface system 710.

Processing system 702 loads and executes software 706 from storage system 704. Processing system 702 may be or reside on, for example, communication device 102. Software 706 includes application 712, which is representative of a software application executed by a processor and programmed to execute the methods described herein. When executed by processing system 702 to provide external device notifications, application 712 directs processing system 702 to operate as described herein for at least the various processes, operational scenarios, and sequences discussed in the foregoing implementations. Computing system 700 may optionally include additional devices, features, or functionality not discussed for purposes of brevity.

Referring still to FIG. 7, processing system 702 may comprise a micro-processor and other circuitry that retrieves and executes software 706 from storage system 704. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 704 may comprise any computer readable storage media readable by processing system 702 and capable of storing software 706. Storage system 704 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. As used herein, “computer readable storage media” excludes a propagated signal.

In addition to computer readable storage media, in some implementations, storage system 704 may also include computer readable communication media over which at least some of software 706 may be communicated internally or externally. Storage system 704 may be implemented as a single storage device, but may also be implemented across multiple storage devices or sub-systems co-located or distributed relative to each other. Storage system 704 may comprise additional elements, such as a controller, capable of communicating with processing system 702 or possibly other systems.

Software 706 in general, and application 712 in particular, may be implemented in program instructions and among other functions may, when executed by processing system 702, direct processing system 702 to operate as described with respect to the various operational scenarios, sequences, and processes illustrated herein. For example, application 712 may include program instructions for facilitating an external device notification process such at that described in an external device notification process 500 or operational sequence 600.

In particular, the program instructions may include various components or modules that cooperate or otherwise interact to carry out the various processes and operational scenarios described herein. The various components or modules may be embodied in compiled or interpreted instructions, or in some other variation or combination of instructions. Software 706 may include additional processes, programs, or components, such as operating system software, virtual machine software, or other application software, in addition to or that include application 712. Software 706 may also comprise firmware or some other form of machine-readable processing instructions executable by processing system 702.

In general, application 712 may, when loaded into processing system 702 and executed, transform a suitable apparatus, system, or device (of which computing system 700 is representative) overall from a general-purpose computing system into a special-purpose computing system customized to enhance entity classification operations. Indeed, encoding application 712 on storage system 704 may transform the physical structure of storage system 704. The specific transformation of the physical structure may depend on various factors in different implementations of this description. Examples of such factors may include, but are not limited to, the technology used to implement the storage media of storage system 704 and whether the computer-storage media are characterized as primary or secondary storage, as well as other factors.

For example, if the computer readable storage media are implemented as semiconductor-based memory, application 712 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 708 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 710 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 710. In some cases, the input and output devices may be combined in a single device, such as a display capable of displaying images and receiving touch gestures. The aforementioned user input and output devices are well known in the art and need not be discussed at length here.

User interface system 710 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface, in which a user interface to an application may be presented.

Communication between computing system 700 and other computing systems (not shown), may occur over a communication network or networks and in accordance with various communication protocols, combinations of protocols, or variations thereof. Examples include intranets, intemets, the Internet, local area networks, wide area networks, wireless networks, wired networks, virtual networks, software defined networks, data center buses, computing backplanes, or any other type of network, combination of network, or variation thereof. The aforementioned communication networks and protocols are well-known and need not be discussed at length here. In any of the aforementioned examples in which data, content, or any other type of information is exchanged, the exchange of information may occur in accordance with any of a variety of well-known data transfer protocols.

A technical effect provided by the technology disclosed herein includes the ability of an external device, in response to receiving a user input, to activate a conferencing application on a connected communication device and to send to the conferencing application a notification type, which allows the conferencing application to automatically join a user to a conference session without further user interaction.

Certain inventive aspects may be appreciated from the foregoing disclosure, of which the following are various examples.

### EXAMPLE 1

A computing apparatus comprising: one or more computer readable storage media; a processing system operatively coupled with the one or more computer readable storage media; and program instructions stored on the one or more computer readable storage media for automatically joining a user to a conference session that, when executed by the processing system, direct the processing system to at least: detect an invocation of an application; in response to detection of the invocation, send a context request to an external device; receive from the external device a context response comprising a notification type; determine whether the notification type corresponds with a meeting type; and automatically join a user to the conference session within the application if the notification type corresponds with the meeting type.

### EXAMPLE 2

The computing apparatus of Example 1 wherein, to detect the invocation of the application, the program instructions direct the processing system to detect a change in a process status of the application from a background status to a foreground status.

### EXAMPLE 3

The computing apparatus of Examples 1-2 wherein the program instructions further direct the processing system to: determine whether the notification type corresponds with a missed call type; automatically display a list within the application comprising at least one missed call if the notification type corresponds with the missed call type; determine whether the notification type corresponds with a missed instant message type; automatically display a list within the application comprising at least one missed instant message if the notification type corresponds with the missed instant message type; determine whether the notification type corresponds with a voicemail type; and automatically display a list within the application comprising at least one voicemail if the notification type corresponds with the voicemail type.

### EXAMPLE 4

The computing apparatus of Examples 1-3 wherein, to send the context request to the external device, the program instructions further direct the processing system to communicate the context request to the external device via a wireless protocol.

### EXAMPLE 5

The computing apparatus of Examples 1-4 wherein the wireless protocol comprises one of a near field communication protocol, a WiFi protocol, and a Bluetooth protocol.

### EXAMPLE 6

The computing apparatus of Examples 1-5 wherein, to send the context request to the external device, the program instructions further direct the processing system to communicate the context request to the external device via a wired protocol.

### EXAMPLE 7

The computing apparatus of Examples 1-6 wherein the program instructions further direct the processing system to send a context message to the external device comprising an instruction to remove the notification type on the external device.

### EXAMPLE 8

The computing apparatus of Examples 1-7 wherein the program instructions further direct the processing system to send a context message to the external device comprising an instruction to populate the external device with the notification type.

### EXAMPLE 9

A method for automatically joining a user to a conference session, the method comprising: detecting an invocation of a client application; in response to detecting the invocation, sending a context request to an external device; receiving from the external device a context response comprising a notification type; determining whether the notification type corresponds with a meeting type; and automatically joining a user to the conference session within the client application if the notification type corresponds with the meeting type.

### EXAMPLE 10

The method of Example 9 wherein, detecting the invocation comprises detecting a change in a process status of the client application from a background status to a foreground status.

### EXAMPLE 11

The method of Examples 9-10 further comprising: determining whether the notification type corresponds with a missed call type; automatically displaying a list within the client application comprising at least one missed call if the notification type corresponds with the missed call type.

determining whether the notification type corresponds with a voicemail type; and

automatically displaying a list within the client application comprising at least one voicemail if the notification type corresponds with the voicemail type.

### EXAMPLE 12

The method of Examples 9-11 wherein sending the context request to the external device further comprises communicating the context request to the external device via a wireless protocol.

### EXAMPLE 13

The method of Examples 9-12 wherein the wireless protocol comprises one of a near field communication protocol, a WiFi protocol, and a Bluetooth protocol.

### EXAMPLE 14

The method of Examples 9-13 wherein sending the context request to the external device further comprises communicating the context request to the external device via a wired protocol.

### EXAMPLE 15

The method of Examples 9-14 further comprising sending a context message to the external device comprising an instruction to remove the notification type on the external device.

### EXAMPLE 16

The method of Examples 9-15 further comprising sending a context message to the external device comprising an instruction to populate the external device with the notification type.

### EXAMPLE 17

A communication device comprising: one or more computer readable storage media; and program instructions stored on the one or more computer readable storage media for automatically joining a user to a conference session that, when executed by a processing system, direct the processing system to at least: request a notification type from an external device in response to invocation of a conferencing client application running on the communication device; determine, in response to receiving the notification type from the external device, a classification of the notification type; and if the classification corresponds with a meeting type, automatically join a user to the conference session within the conferencing client application.

### EXAMPLE 18

The one or more computer readable storage media of Example 17 wherein, if the classification corresponds with a missed call type, the program instructions further direct the processing system to automatically display a list comprising at least one missed call in a missed call user experience within the conferencing client application; wherein, if the classification corresponds with a missed instant message type, the program instructions further direct the processing system to automatically display a list comprising at least one missed instant message in a missed instant message user experience within the conferencing client application; and wherein, if the classification corresponds with a voicemail type, the program instructions further direct the processing system to automatically display a list within the conferencing client application comprising at least one voicemail in a voicemail user experience within the conferencing client application.

### EXAMPLE 19

The one or more computer readable storage media of Examples 17-18 wherein the program instructions further direct the processing system to send the notification type to the external device in response to a notification trigger event corresponding with the notification type within the conferencing client application.

### EXAMPLE 20

The one or more computer readable storage media of Examples 17-19 wherein the external device comprises a speakerphone.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A computing apparatus comprising:
one or more computer readable storage media;
a processing system operatively coupled with the one or more computer readable storage media; and
program instructions stored on the one or more computer readable storage media for automatically joining a user to a conference session that, when executed by the processing system, direct the processing system to at least:
detect an invocation of an application;
in response to detection of the invocation, send a context request to an external device;
receive from the external device a context response comprising a notification type;
determine whether the notification type corresponds with a meeting type; and
automatically join a user to the conference session within the application if the notification type corresponds with the meeting type.

2. The computing apparatus of claim 1, wherein, to detect the invocation of the application, the program instructions direct the processing system to detect a change in a process status of the application from a background status to a foreground status.

3. The computing apparatus of claim 1, wherein the program instructions further direct the processing system to:
determine whether the notification type corresponds with a missed call type;
automatically display a list within the application comprising at least one missed call if the notification type corresponds with the missed call type;
determine whether the notification type corresponds with a missed instant message type;
automatically display a list within the application comprising at least one missed instant message if the notification type corresponds with the missed instant message type;
determine whether the notification type corresponds with a voicemail type; and
automatically display a list within the application comprising at least one voicemail if the notification type corresponds with the voicemail type.

4. The computing apparatus of claim 1, wherein, to send the context request to the external device, the program instructions further direct the processing system to communicate the context request to the external device via a wireless protocol.

5. The computing apparatus of claim 4, wherein the wireless protocol comprises one of a near field communication protocol, a WiFi protocol, and a Bluetooth protocol.

6. The computing apparatus of claim 1, wherein, to send the context request to the external device, the program instructions further direct the processing system to communicate the context request to the external device via a wired protocol.

7. The computing apparatus of claim 1, wherein the program instructions further direct the processing system to send a context message to the external device comprising an instruction to remove the notification type on the external device.

8. The computing apparatus of claim 1, wherein the program instructions further direct the processing system to send a context message to the external device comprising an instruction to populate the external device with the notification type.

9. A method for automatically joining a user to a conference session, the method comprising:
detecting an invocation of a client application;
in response to detecting the invocation, sending a context request to an external device;
receiving from the external device a context response comprising a notification type;
determining whether the notification type corresponds with a meeting type; and
automatically joining a user to the conference session within the client application if the notification type corresponds with the meeting type.

10. The method of claim 9, wherein, detecting the invocation comprises detecting a change in a process status of the client application from a background status to a foreground status.

11. The method of claim 9 further comprising:
determining whether the notification type corresponds with a missed call type;
automatically displaying a list within the client application comprising at least one missed call if the notification type corresponds with the missed call type.
determining whether the notification type corresponds with a voicemail type; and
automatically displaying a list within the client application comprising at least one voicemail if the notification type corresponds with the voicemail type.

12. The method of claim 9, wherein sending the context request to the external device further comprises communicating the context request to the external device via a wireless protocol.

13. The method of claim 12, wherein the wireless protocol comprises one of a near field communication protocol, a WiFi protocol, and a Bluetooth protocol.

14. The method of claim 9, wherein sending the context request to the external device further comprises communicating the context request to the external device via a wired protocol.

15. The method of claim 9 further comprising sending a context message to the external device comprising an instruction to remove the notification type on the external device.

16. The method of claim 9 further comprising sending a context message to the external device comprising an instruction to populate the external device with the notification type.

17. A communication device comprising:
one or more computer readable storage media; and
program instructions stored on the one or more computer readable storage media for automatically joining a user to a conference session that, when executed by a processing system, direct the processing system to at least:
request a notification type from an external device in response to invocation of a conferencing client application running on the communication device;
determine, in response to receiving the notification type from the external device, a classification of the notification type; and
if the classification corresponds with a meeting type, automatically join a user to the conference session within the conferencing client application.

18. The one or more computer readable storage media of claim 17, wherein, if the classification corresponds with a missed call type, the program instructions further direct the processing system to automatically display a list comprising at least one missed call in a missed call user experience within the conferencing client application;
wherein, if the classification corresponds with a missed instant message type, the program instructions further direct the processing system to automatically display a list comprising at least one missed instant message in a missed instant message user experience within the conferencing client application; and
wherein, if the classification corresponds with a voicemail type, the program instructions further direct the processing system to automatically display a list within the conferencing client application comprising at least one voicemail in a voicemail user experience within the conferencing client application.

19. The one or more computer readable storage media of claim 17, wherein the program instructions further direct the processing system to send the notification type to the external device in response to a notification trigger event corresponding with the notification type within the conferencing client application.

20. The one or more computer readable storage media of claim 19, wherein the external device comprises a speakerphone.
